(19) United States
(12) Patent Application Publication
(10) Pub. No.: US 2007/0016961 A1
(43) Pub. Date: Jan. 18, 2007

(54) Application revocation using an application revocation list in a portable electronic device

(76) Inventors: Dean H. Vogler, Algonquin, IL (US); Ezzat A. Dabbish, Cary, IL (US); Larry C. Puhl, Huntley, IL (US)

Correspondence Address: MOTOROLA, INC., 1303 EAST ALGONQUIN ROAD, IL01/3RD, SCHAUMBURG, IL, 60196, US

(21) Appl. No.: 11/178,759

(22) Filed: Jul. 11, 2005

(51) Int. Cl. G06F 17/30

(52) U.S. Cl. 726/30

(57) ABSTRACT

A portable electronic device (110) contains an application revocation list (ARL) in memory (135) comprising at least one application identifier (AI) uniquely identifying an application. The portable electronic device also contains an application list memory (133) for storing at least application identifiers for trusted applications in the device. A processor (120) operatively connected to the memory determines whether an application identifier on the application revocation list matches an application identifier on the portable electronic device, and, if so, processes a revocation of the application. The application revocation list can be wirelessly updated. Application software in a portable electronic device can thus subsequently be revoked through operation of this application revocation list. A remote server (140) makes application revocation lists available to portable electronic devices over a network such as a cellular system.

### BACKGROUND OF THE INVENTIONS

1. Technical Field

The present inventions relate to revocation of software applications and, more particularly, relate to the revocation of software applications using a revocation list in a portable electronic device.

2. Description of the Related Art

The security of devices (such as a cellular phone) is important and is beginning to be addressed. Some manufacturers of devices have implemented integrity and authenticity checks of software that runs on the device. This may include the OS, device drivers, base code, libraries, and user applications. The term Secure Boot is used to denote the concept of verifying software in an unbroken chain from the Boot ROM to applications. Such a device may be viewed as a trusted device, and the device is said to contain a trusted platform. Some of the characteristics of a trusted platform may include:
Only trusted software (signed by a trusted authority) is allowed to run on a phone;
Secure boot ensures chain of trust from hardware, ROM, OS, base code, user applications, etc.;
Software components contain a cryptographic signature; and
An implicitly trusted secure boot code (i.e., software stored in tamper-proof ROM) cryptographically verifies all software components.

As on a personal computer, platforms that allow software to be loaded and executed from a variety of sources/vendors can also make it possible for hackers to exploit it. However, the potential consequences in a wireless system may be worse than on a personal computer. For example, a hacker could create a Trojan horse program that turns on phone transmitters continuously, or sends constant phone messages in a denial-of-service attack on the wireless infrastructure.

A secure software lifecycle may be viewed as having three components: prevention, detection, and response. Prevention is done by screening and evaluating the software, which may include screening the software vendor. A trusted signing server, or trusted authority, is expected to address these issues before giving its stamp of approval. Its stamp, namely a cryptographic signature of the software, is an assurance given by the trusted authority, to all devices that receive the software package, that the software has been signed by it. Detection is the ability to determine whether the approved software has been tampered with. If the device verifies the software package, that is an assurance that the software has been received in the same condition as it was when it was signed by the trusted authority. Nominally, a trusted device will not launch software that is not signed, nor will it launch software that failed the signature verification process.

The “response” component refers to the ability to take action on software that is noncompliant. An example of a response mechanism is, if a software package fails the verification step, the device can prevent the software from being run. This is an example of a response due to an event that occurred after the trusted authority signed the software. But, responding to an event that traces itself prior to that, in the prevention phase, is more problematic. What response can be done if there was an incident of some sort in the prevention phase? Normally, if the software has been signed by a trusted authority, then it will pass verification by the device. How can an action be taken against software when it is found to be noncompliant, or rogue, after it has been signed by a trusted authority and delivered to the device?

There is the chance that an application should be revoked after it has been released to the public. Some possible reasons include:
A software bug was found (e.g., date rollover causes buffer overflow which crashes the device);
A Trojan horse was embedded in software (e.g., does something malicious after being hidden within the package); and
A vendor/hacker tricked the signing server (e.g., the credentials presented to signing server were sufficient to get a legitimate signature).

Current and future devices will increasingly contain software developed by vendors outside of the control of the manufacturer of such devices. Devices that contain legitimately signed software need to have a procedure to remove applications that are deemed “bad”. The term application revocation is used generically to describe this capability.

### BRIEF DESCRIPTION OF THE DRAWINGS

FIG. 1 illustrates a schematic block diagram of a portable electronic device according to an embodiment of the present inventions;

FIG. 2 illustrates an alternative embodiment of the memory of the portable electronic device containing an application revocation list according to the present inventions;

FIG. 3 illustrates a flow chart of application revocation in a portable electronic device according to some embodiments of the present inventions;

FIG. 4 illustrates a flow chart of application revocation list creation by a trusted authority in accordance with some embodiments of the present invention; and

FIG. 5 illustrates a flow chart of application revocation list distribution on a network according to some embodiments of the present inventions.

### DETAILED DESCRIPTION OF THE PREFERRED EMBODIMENTS

Trusted applications can be revoked within a portable electronic device. At least one of the applications within the portable electronic device has an application identifier (ID). The portable electronic device can be a cellular 10 telephone or radiotelephone or other device such as a PIM (Personal Information Manager), PDA (Personal Digital Assistant), gaming console, pager, portable computer, a set-top box, or an mp3 music player and digital camera or portable video recorder.

The portable electronic device is typically a trusted portable electronic device. Trusted here means that we trust the chain of software events up to and until the application is obtained within the portable electronic device. The applications within the portable electronic device are typically applications signed by a trusted authority. Each application within the portable electronic device typically has an application certificate containing the application identifier and an application signature. The portable electronic device comprises a revocation application for performing the revocation process and determining which if any applications to revoke. The revocation application is also a trusted application.

A portable electronic device may contain an application revocation list (ARL) comprising at least one application identifier for each application on the list. The application revocation list is preferably signed so that when the portable electronic device receives it, it can be trusted because its source can be verified. The application identifier uniquely identifies the application. The application identifier can identify more than a single application. The application identifier can identify an application software package. This package can be a collection of installed code, post-installed code, multiple pieces of code, and non-contiguous code. The portable electronic device maintains the relationship between an application identifier and the application software package. Hereafter, reference to an application that is associated with an application identifier should be understood to also include an application software package

The application revocation list is a new security credential that contains information that revokes an application. At a minimum, it must include an application identifier linked to the application. The application revocation list may optionally contain a timestamp value associated with each application identifier. The revocation application may use the timestamp information for managing its revocation processing activities by date. Using the example of the Product Certificate as described in U.S. Pat. No. 6,223,291, by the same inventors as the present inventions, and hereby incorporated by reference, the Product Certificate may include the following items:

Issuer (Signer)
Issue date
Expiration date
Subject (Software Application Identifier)
Hash of software
..........
Signature

The Application Identifier in the application revocation list would be linked to the Subject field of such a Product Certificate. Whenever an application is launched, a trusted verification application on the portable electronic device checks the application revocation list to see whether the application's identifier is on it. The application revocation list itself is signed by a trusted authority, so before the application revocation list is processed; it must first be verified by the device. This prevents anyone such as a hacker from creating fake application revocation lists to subvert the system. If an application is found to be on the application revocation list, then it is considered to be revoked. The portable electronic device will process revoked applications according to a security policy. For example, the security policy might prevent the revoked application from running, or it may remove the application from the device, or it may force the device to look for an update from a server.

When a portable electronic device receives an application revocation list, one of the steps required before processing the application revocation list is to first verify the authenticity of the application revocation list by verifying its signature. Then, the portable electronic device determines whether application identifiers on the application revocation list match application identifiers within the portable electronic device. Such can be performed by comparing the application revocation list against the application list (i.e., which contains an association between application identifiers and the applications themselves) maintained by the portable electronic device. If an application identifier on the application revocation list matches an application identifier within the portable electronic device, the application so identified is revoked. Revocation of the application can be processed within the portable electronic device in a number of ways. One way of processing the revocation of the application within the portable electronic device is to remove the application. Another way of processing the revocation of the application within the portable electronic device is to delete the application from memory. Another way of processing the revocation of the application within the portable electronic device is to move the application into a restricted area of memory of the portable electronic device. Another way of processing the revocation of the application within the portable electronic device is to disable the application. Another way of processing the revocation of the application within the portable electronic device is to mark the application as revoked. These are non-limiting examples of revocation of an application.

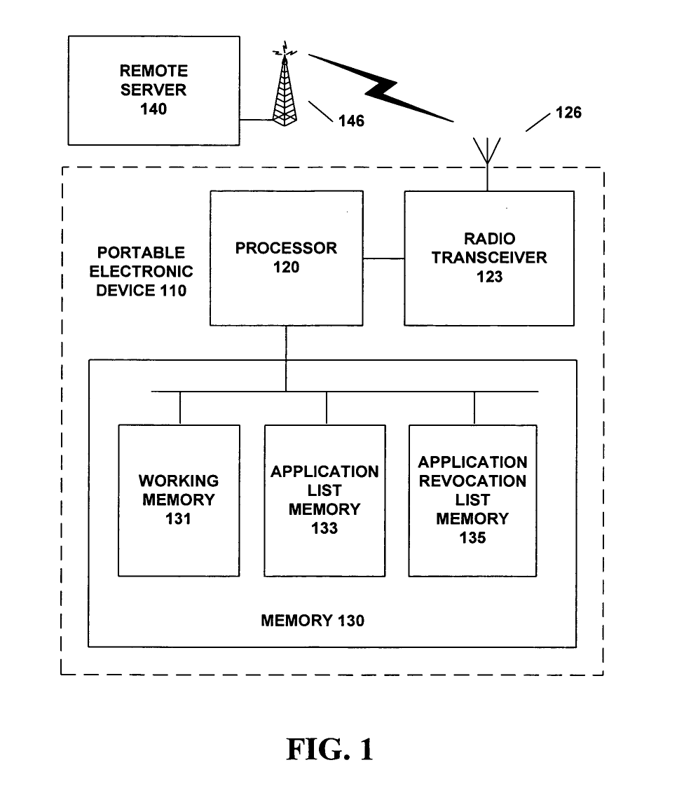

FIG. 1 illustrates a schematic block diagram of a portable electronic device 110 having a processor 120, a radio transceiver 123 and memory 130 for operation of the portable electronic device. The memory 130 stores application information for the portable electronic device 110. An application list memory 133 stores a list of the applications in the portable electronic device 110. An application revocation list memory 135 stores the application revocation list. The application revocation list stored in the application revocation list memory 135 contains at least one application identifier for each application on the application revocation list. The application identifiers stored in the application revocation list are indicative of applications to be revoked. The application list stored in the application list memory 133 contains application identifiers corresponding to each application within the device regardless of its revocation status. The working memory 131 provides the scratch pad or random-access memory for operation of the portable electronic device. The working memory 131 may also contain the software code itself for each of the applications on the application list.

The portable electronic device 110 has an antenna 126 connected to the radio transceiver 123. The portable electronic device 110 communicates with a remote server 140 via a base antenna 146 over a communications network. The radio transceiver 123 can be a cellular telephone transceiver which allows the portable electronic device 110 to transmit and receive voice traffic with a public switched telephone network PSTN. The radio transceiver 123 also allows the portable electronic device to wirelessly receive new application revocation lists for storage in the application revocation list memory 135.

The processor 120 performs operating functions of the portable electronic device 110. One operating function performed by the processor 120 is determining whether an application identifier on the application revocation list matches an application identifier of an application that runs on the portable electronic device, and if so processing a revocation of the application corresponding to the application identifier.

(For compactness, “an application identifier of an application that runs on the portable electronic device” may be alternatively expressed as “an application identifier of an application on the portable electronic device” or “an application identifier on the portable electronic device”)

The memory 130 may contain a restricted area wherein an application is moved upon processing of a revocation. Alternatively the processor 120 may disable the application processed for revocation, or it may delete from the memory 130 the application processed for revocation, or it may disable the application in memory.

The radio transceiver 123 of the portable electronic device 110 may query the remote server 140 to search for and receive an application revocation list and store it in the application revocation list memory 135. The remote server 140 may be operated by the manufacturer of the portable electronic device or by the service provider of the communications network or by a trusted authority. The portable electronic device 110 may have more than one application revocation list stored in the application revocation list memory 135. The portable electronic device would process each application revocation list.

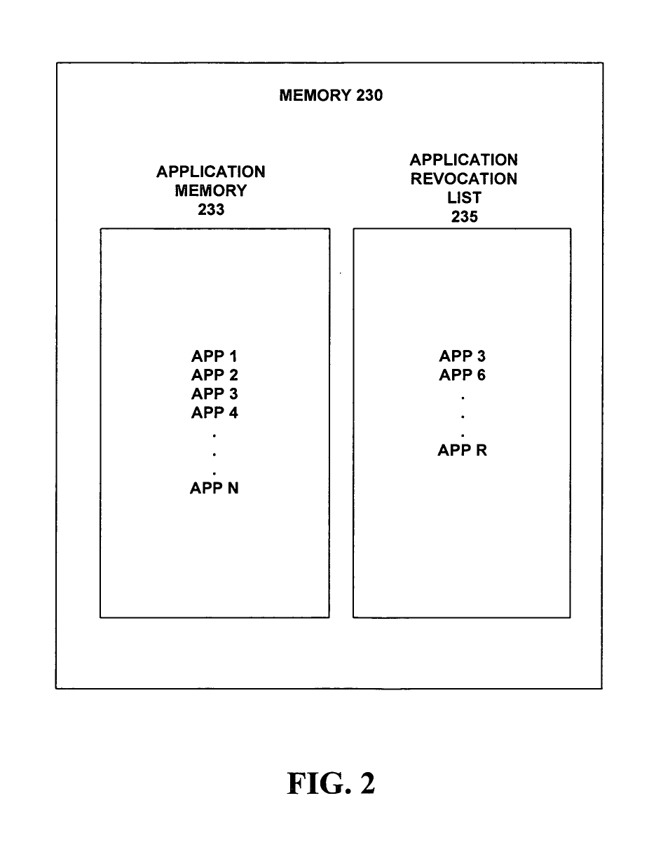

FIG. 2 illustrates an alternative embodiment of the memory contents of the portable electronic device containing an application revocation list. Memory 230 may contain an application memory 233 and an application revocation list 235. The application memory 233 contains the software code itself for the applications themselves. Rather than storing a list of application identifiers in memory 233, in the alternative embodiment of FIG. 2, the applications themselves are stored in the application memory.

The portable electronic device can derive a list of application identifiers from the applications stored in the application memory 233. The list could be stored in working memory or added to the application memory. The applications are illustrated in FIG. 2 as APP 1, APP 2, APP 3, APP 4 . . . APP N. This list can be derived form application identifiers stored within the code of each application.

Additionally, application identifiers themselves might not be contained within the code of each application or within a certificate associated with each application. Thus application identifiers may be derived too by the portable electronic device. One way to derive an application identifier from an application is to hash the application code using a hash algorithm. The result of the hashing would then be used as the application identifier for that application.

The application identifiers can be many bytes long, but could be as short as one byte. The result of a hash using SHA-1, for example, is 20 bytes.

The application revocation list 235 may contain a list of application identifiers for applications that have been revoked. The application revocation list 235 may also contain a signature of its data. It is possible that none of the applications in the application space 233 are listed in the application revocation list 235. It is also possible that the application revocation list 235 contains application identifiers for applications which are not present on a given portable electronic device.

In the alternative embodiment of FIG. 2, the application identifiers on the application revocation list 235 are compared against identifier data of the applications themselves. An alternative approach would be to compare the application identifiers of the revocation list against the application identifiers themselves for the applications stored in the memory 230 of the portable electronic device. The application identifiers for the applications stored in the memory 230 of the portable electronic device can thus be represented in different ways including a separate list or within the applications themselves.

The application memory 233 can be contained in more than one place in the portable electronic device. The application memory 233 can also be located external to the portable electronic device, for example, as part of an accessory such as a camera attachment. What is important is that the processor 120 in the portable electronic device 110 can access this memory.

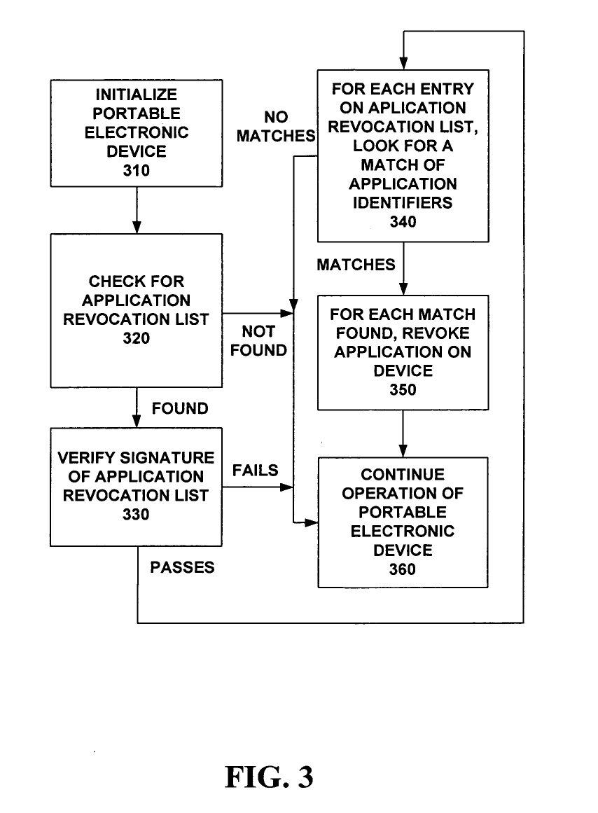

FIG. 3 illustrates a flow chart of application revocation in a portable electronic device according to the present invention. The application revocation process can begin once the portable electronic device is initialized in step 310. At step 320, the portable electronic device checks for the presence of an application revocation list in its memory. If no application revocation list is found, at step 320, in this embodiment the portable electronic device continues operation processing at step 360. If an application revocation list is found at step 320, the portable electronic device then verifies the signature of the application revocation list at step 330, to confirm that the application revocation list is trusted such as having been signed by a trusted authority. When the signature verification of step 330 fails, the application revocation list is ignored and in this embodiment the portable electronic device continues operation processing at step 360. When the signature verification of step 330 passes, flow continues to step 340. At step 340, for each entry on the application revocation list, the portable electronic device looks for a match of application identifiers on the application revocation list and the application list on the portable electronic device. If no matches are found in step 340, in this embodiment flow jumps to step 360. If matches are found in step 340, for each match of application identifiers found between the application revocation list and the application identifiers of the applications in the portable electronic device, the application corresponding to each match is revoked at step 350, according to a security policy. The application can be revoked according to a number of different techniques such as moving the application code to a partitioned area in memory, removing or deleting the application code from memory, marking the application as revoked such as with a flag bit, or disabling the application, or it may direct the device to a remote server to obtain an updated version of the application.

Finally in FIG. 3, step 360 illustrates a step for operation of the other functions of the portable electronic device. In an alternative embodiment, steps 320 through 350 can be performed later during operation.

It is important for a trusted system to verify applications, if they are signed. If signature verification of applications is implemented, then the applications can be considered trusted if they are successfully verified. Although verifying the applications enhances the security, it is not a necessary step in the revocation process itself. The verification of applications can happen at any time, which is after step 360 or before step 310, or between steps 310 and 360.

Variations of the application revocation described with reference to FIG. 3 that accomplish a similar result are apparent to one of ordinary skill in the art. For example, steps 340 and 350 could be replaced by steps that are processed only when an application is called into use.

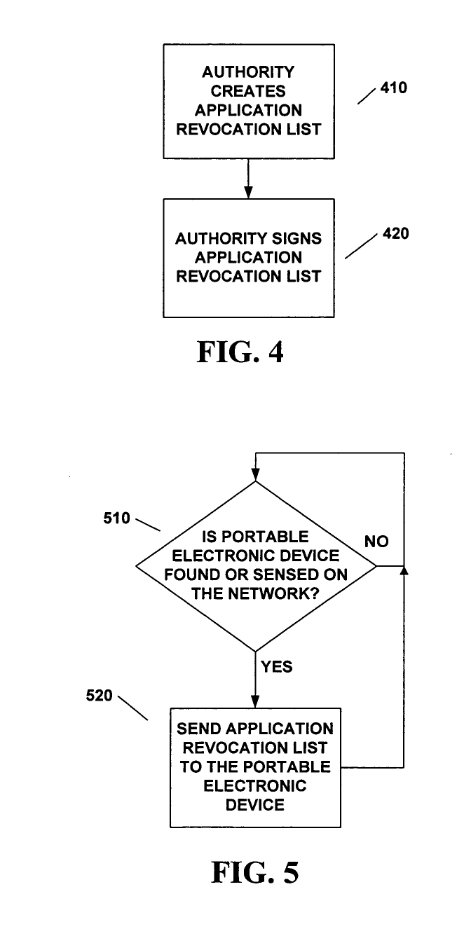

FIG. 4 illustrates a flow chart of application revocation list creation by a trusted authority. The portable electronic device has applications available to it. These applications can be loaded into a memory of the portable electronic device for use by the portable electronic device. Afterwards, though, perhaps a problem with an application is found by an entity such as the application provider. On the other hand, a different entity such as the device manufacturer or system operator may discover a problem with one or more applications and require the application be revoked. The trusted authority can then act as an authority to put the application on a signed application revocation list as described in steps 410 and 420.

In step 410 a trusted authority creates an application revocation list. The application revocation list contains application identifiers corresponding to applications to be revoked by recipient portable electronic devices. The trusted authority at step 420 then signs the application revocation list to provide assurance to devices that the application revocation list is trusted. One advantage of the embodiments of the present inventions is that the trusted authority can be different entities. The trusted authority may be the portable electronic device manufacturer, a system operator for the portable electronic device, or some other trusted authority. Another advantage of the embodiments of the present inventions is that the entity that determines which applications are placed on an application revocation list can be a different entity than the authorities that signed the applications.

FIG. 5 illustrates a flow chart of application revocation list distribution on a network according to the present invention. The application revocation list is obtained by the portable electronic device from a remote location. In a wireless device the application revocation list is typically obtained wirelessly. The application revocation list is delivered to the portable electronic devices over a network in a number of different ways. The application revocation list can be pushed to the portable electronic device. Pushing does not require a request by the portable electronic device. Pushing has the advantage of making a new application revocation list available when updates are available or network resources permit. In one embodiment, pushing of the application revocation list to the portable electronic device can occur when the portable electronic device accesses the network.

In order to deliver the application revocation list, at step 510, a remote server on the communications network observes whether the portable electronic device is found or sensed on the network. The portable electronic device may be found or sensed on the network at the time that it registers upon power up. Alternatively the portable electronic device may be live on the network when the server is ready to check for its presence. If not, then step 510 is repeated until the portable electronic device is sensed on the network. When the portable electronic device is sensed on the network, step 520 will send the application revocation list to the portable electronic device. This allows the remote server to push the application revocation list to the portable electronic device. As an alternative to pushing, the portable electronic device can request application revocation list updates from a remote server upon power up or at other instances such as installation of new applications, or by user request, or even according to a predetermined schedule.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although application revocation in cellular phone examples are disclosed, the inventions are applicable to a personal digital assistant, a gaming console, pager, portable computer, a set-top box or an mp3 music player and a digital camera or portable video recorder.

What is claimed is:

1. An application revocation method for revoking trusted applications within a portable electronic device comprising at least one application having an application identifier, the revocation method comprising the steps of:
(a) obtaining contents of an application revocation list, the application revocation list comprising at least one application identifier; and
(b) determining whether an application identifier in the application revocation list matches an application identifier of an application on the portable electronic device, and if so processing a revocation of the application.

2. An application revocation method according to claim 1, wherein the contents of an application revocation list obtained in said step (a) comprises at least one application identifier identifying a package of applications.

3. An application revocation method according to claim 1, wherein the contents of an application revocation list obtained in said step (a) comprise at least one application identifier that uniquely identifies the application.

4. An application revocation method according to claim 1, wherein an application identifier on the portable device may be derived from the application.

5. An application revocation method according to claim 1, wherein the contents of an application revocation list obtained in said step (a) include a timestamp value associated with the application identifier.

6. An application revocation method according to claim 1, wherein the application revocation list is signed.

7. An application revocation method according to claim 1, wherein the revocation method further comprises the step of (c) verifying the authenticity of the application revocation list.

8. An application revocation method according to claim 1, wherein the revocation method further comprises the step of (c) processing more than one application revocation list.

9. An application revocation method according to claim 1,
wherein the portable electronic device comprises a revocation application; and
wherein said step (b) of determining is performed by the revocation application.

10. An application revocation method according to claim 1, wherein the processing of the revocation of the application in said step (b) comprises the substep of (b1) removing the application or (b2) restricting or disabling the application.

11. An application revocation method according to claim 1, wherein said step (a) of obtaining the contents of the application revocation list obtains the application revocation list from a remote location.

12. An application revocation method according to claim 1, comprising the step of (c) pushing the application revocation list to the portable electronic device.

13. An application revocation method according to claim 12, wherein said step (c) of pushing comprises pushing the application revocation list to the portable electronic device when the portable electronic device is sensed on a network.

14. An application revocation method according to claim 1,
wherein applications in the portable electronic device are signed by a trusted authority; and
wherein the entity that determines which applications are placed on the application revocation list is a different entity than the trusted authority that signed the applications.

15. A portable electronic device, comprising:
memory for storing trusted applications, wherein at least one trusted application has an application identifier;
memory for storing contents of at least one application revocation list, the application revocation list comprising at least one application identifier; and
a processor operatively connected to the memory to determine whether an application identifier on the application revocation list matches an application identifier on the portable electronic device, and if so processing a revocation of the application.

16. A portable electronic device according to claim 15, wherein the portable electronic device is a trusted portable electronic device.

17. A portable electronic device according to claim 15, wherein the processor restricts or disables the application processed for revocation or removes from the memory the application processed for revocation.

18. A portable electronic device according to claim 15,
wherein the portable electronic device comprises a communications transceiver; and
wherein the portable electronic device queries to obtain data for the application revocation list.

19. A portable electronic device according to claim 15, comprising more than one application revocation list.

20. A system wherein applications on a portable electronic device can be revoked over a network, comprising:
a remote server for making application revocation lists available on the network; and
a portable electronic device, comprising a communications transceiver for communicating with the remote server over the network to obtain application revocation lists; memory for storing contents of the application revocation lists, each application revocation list comprising at least one application identifier; and a processor operatively connected to the memory to determine whether an application identifier on the application revocation list matches an application identifier for an application on the portable electronic device, and if so processing a revocation of the application so matched.
